(19) United States
(12) Patent Application Publication
(10) Pub. No.: US 2016/0229514 A1
(43) Pub. Date: Aug. 11, 2016

(54) MODULAR LONG WINDOW FOR AIRCRAFT CABINS

(71) Applicant: MSA AIRCRAFT PRODUCTS, INC., SAN ANTONIO, TX (US)

(72) Inventors: NICHOLAS C. MOHAT, San Antonio, TX (US); Steve Fillippi, Converse, TX (US); Hung Pham, San Antonio, TX (US); Lionel Hudek, Adkins, TX (US); Michael D. Hughes, San Antonio, TX (US); Matt Anderson, Spring Branch, TX (US)

(21) Appl. No.: 14/832,593

(22) Filed: Aug. 21, 2015

Related U.S. Application Data
(60) Provisional application No. 62/040,760, filed on Aug. 22, 2014.

(51) Int. Cl. B64C 1/14; E06B 9/76; E06B 9/322; E06B 9/74; E06B 9/262; E06B 9/264

(52) U.S. Cl. CPC B64C 1/1484; E06B 9/262; E06B 9/264; E06B 9/322; E06B 9/74; E06B 9/76; E06B 2009/2625; E06B 2009/2643; E06B 2009/2452

(57) ABSTRACT

Various systems, processes, and techniques may be used for producing a long modular window assembly for an aircraft. In particular implementations, a long modular window assembly may, among other things, include a frame, a motor, and a shade. The frame may include an inner shell and an outer shell. The inner shell may have a lens opening, and the outer shell an opening but no lens. The frame may have a frame interior. A lens may be provided for engagement to the lens opening of the inner shell. A multiplicity of brackets may attach the frame to engage the assembly to a side wall, typically curved, of an aircraft interior. An electric motor may engage the frame in the frame interior along the frame. A first shade is provided with a shade rail. The shade and the shade rail are dimensioned for receipt into the interior of the frame.

### RELATED APPLICATIONS

This application claims priority to U.S. Patent Application No. 62/040,760, filed Aug. 22, 2014. This prior application is herein incorporated by reference in its entirety.

### FIELD OF THE INVENTION

This application relates to aircraft cabin windows, and more specifically, to modular windows for aircraft cabins.

### BACKGROUND OF THE INVENTION

It is often beneficial to be able to select the amount of light coming through a window in a structure, such as in an aircraft cabin. Custom aircraft cabin windows typically use a pleated shade, including a housing, which is a modular unit having an inner lens with manual or electric controls that allow the passenger to move the shade so as to adjust the amount of light coming through the window.

Applicant incorporates herein by reference, U.S. Pat. No. 4,679,610. The '610 patent is often considered the “pioneer” patent in the area of upscale aircraft cabin windows. The '610 patent discloses a modular, self-contained window insert made of a frame with two panes or lenses of impact resistant plastic, which will prevent the entry of dust into the interior of the unit. A shade, typically in the form of a double accordion collapsible sheet, is placed within the window unit between the inner and outer lenses and can be moved upward and downward by use of a manual or electric control mechanism secured to the frame.

The window assembly in the '610 patent is roughly about as wide as it is tall and is configured to receive light from a single fuselage cabin window as in the '610 patent FIG. 1, element 62. FIGS. 5, 5A, and 5B of the '610 patent show cables 88/90 provided as guides to eliminate vibration and to maintain proper vertical alignment of the shade assembly (i.e., one side being higher than the other) during ascent and descent of the shade. In the '610 patent, there is disclosed a single window shade, a single shade rail, and a single manually operated lever and cable system to manually raise and lower the shade rail.

U.S. Pat. No. 6,481,486 is assigned to Assignee of the present invention and incorporated herein by reference. The '486 patent discloses dual shade rails and dual shades, one stacked upon another. FIGS. 3A-3H of this patent detail the manner in which strings or cords are used to move the shade rails up and down as well as a system of cords and strings that allow maintenance of the shades in a parallel alignment.

Publication US 2009/0283227 (assigned to Assignee of the present invention) and incorporated herein by reference discloses a modular unit having a single shade and belt or chain drive on either side of the shade rail to move a shade, driven by a motor and sprocket, which in turn drives the belt and chain, between an open and closed position. No alignment means are illustrated.

Applicant incorporates herein by reference, U.S. Pat. No. 6,832,641 (assigned to Assignee of the present invention) entitled “Electric Dual Shade Aircraft Window.” In the '641 patent, a side-by-side dual shade is provided for each of the first or second shade having a shade rail. The '641 patent discloses a single belt for each side, one belt attached to one of the rails and driven by one motor on one side of the frame, and the other belt attached to the second rail on the other side of the frame and driven by a second motor. Shades may be engaged with shade leveling cords for alignment to keep the shade rails horizontal as they move between the open and closed position. All of the foregoing are modular shades that typically include a rear lens.

### SUMMARY

The following describes various implementations of a modular window assembly for an aircraft. In particular implementations, a module window assembly, among other things, may include a frame, a motor, and a shade. The frame may have top, bottom, front and rear walls, and side walls and include an inner shell and an outer shell. The inner shell may have a lens opening and the outer shell an opening but no lens. The frame may have a frame interior. A lens may be provided for engagement to the lens opening of the inner shell. A multiplicity of brackets may attach the frame to engage the assembly to a side wall, typically curved, of an aircraft interior. An electric motor may engage the frame in the frame interior along the frame. The motor may include a drive shaft with a drive sprocket on the end thereof. A first shade is provided with a shade rail. The shade and the shade rail are dimensioned for receipt into the interior of the frame. The window assembly may also include an idler sprocket, which may be aligned with the drive shaft but mounted to the frame opposite thereto.

A live axle may be rotatably mounted to the frame on or near the bottom wall thereof, and a first and second pair of following sprockets may be fixedly engaged to the removed ends of the live axle. A belt pair may be provided for engaging the drive and idler sprockets. One of the belt pair may engage the drive sprocket and a first of the following sprockets, and the other belt may engage the idler sprocket and the second following sprocket.

Certain implementations may include a multiplicity of alignment cords that run through the shade. Particular implementations may include at least three cords adapted to maintain alignment of the shade. The cords may be routed from the bottom wall of the frame to the shade rail of the shade, through the shade, and into the top of the frame, with two of the cords traversing from alternate sides of the shade to the other side of the shade and one of the cords traversing from one side of the shade to an area between the other two cords.

Some implementations may include a second electric motor and a second shade. The second electric motor may be mounted to the frame in the frame interior along the frame top, the motor on the opposite side of the frame from the first motor and having a drive shaft with a drive sprocket on the end thereof. The second shade may be mounted inboard of the first shade and have with a shade rail, the second shade and the shade rail dimensioned for receipt into the interior of the frame, the second shade having an upper edge attached to the top of the frame.

Various implementations provide various features. For example, some implementations allow a modular window that has no rear lens. As another example, some implementations provide for a modular window with a lateral axis that is significantly longer than the height (i.e., high aspect ratio) while still allowing shades to function properly. As an additional example, particular implementations provide drive assemblies that maintain proper alignment of long shades as they are raised and lowered.

Other features will be apparent to those skilled in art in view of the following description and the accompanying drawings.

### BRIEF DESCRIPTION OF THE DRAWINGS

FIG. 1 is a perspective view partially cutaway of Applicant's modular long window as viewed from the inside of the aircraft.

FIG. 1A is a perspective view of the modular long window exploded away from a fuselage section FS of an aircraft exterior having fuselage windows FW.

FIG. 2 is a rear or outer elevational view of the inner shell (outer shell removed) of Applicant's modular long window showing the mechanical elements attached on the walls thereof.

FIGS. 3A and 3B are elevational views of the detail of FIG. 2, bottom left corner and bottom right corner, respectively.

FIGS. 3C and 3D show side views of the lower right corner showing a drive belt and follower sprocket in FIG. 3D, and a drive belt in FIG. 3C.

FIG. 4 is a close-up detail of FIG. 2, top right corner of the window, taken from outside the window looking in towards the cabin, showing one motor with a motor sprocket, one idler sprocket, two belts, and the outer shade as well as other details.

FIGS. 4A and 4B are side cutaway views of the drive and idler sprockets on the top right corner of the inside shell.

FIGS. 4A and 3C together show the inner belt on the right side. FIGS. 4B and 3D show the outer belt on the right side.

FIG. 5 is the same view as FIG. 4, but showing the top left-hand corner of FIG. 4 with a second motor, a second idler sprocket, and third and fourth belt, as well as the outer shade.

FIG. 6 illustrates a portion of a shade rail and shade in the manner in which it attaches to the belt.

FIGS. 7 and 7A illustrate the alignment cords for helping to prevent “sagging” of the shades as well as to assist in proper alignment of the shade rails.

FIG. 8 shows a perspective rear view of Applicant's modular long window.

FIG. 9 is a side view of the wire drive manual override with a housing cutaway which may be used with an electric window and, in one embodiment, with the modular long window disclosed herein.

### DETAILED DESCRIPTION OF THE PREFERRED EMBODIMENT

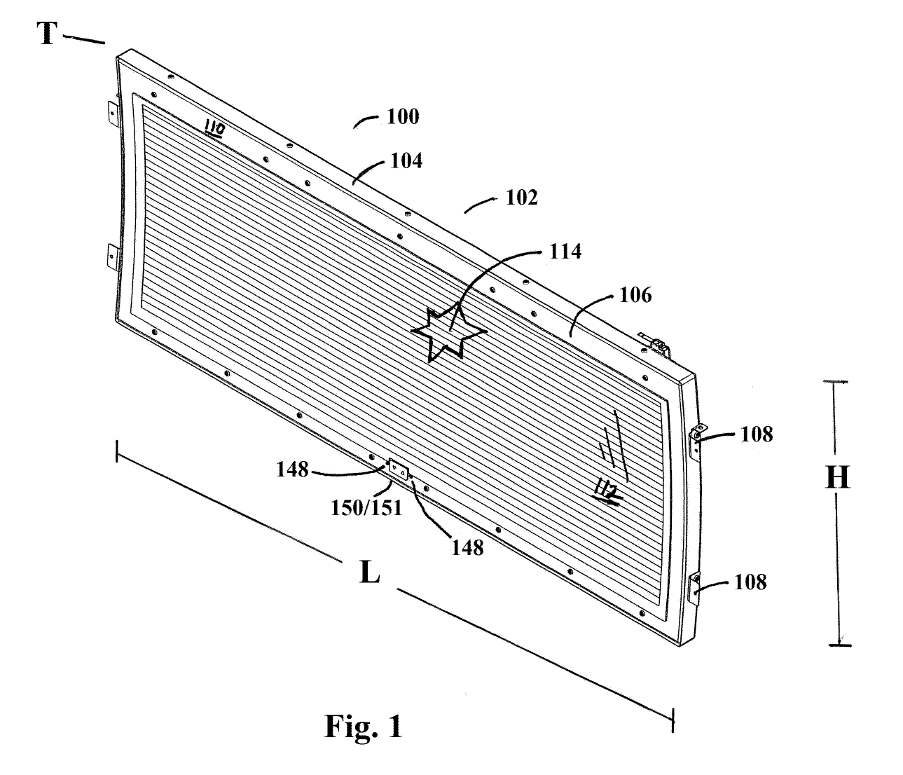

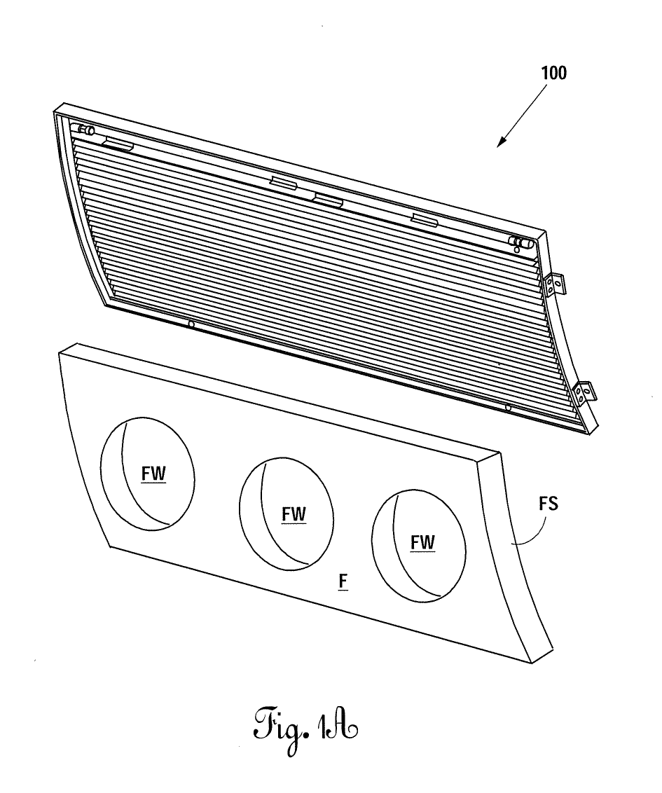

FIGS. 1-7A illustrate Applicant's modular long window 100. Modular long window 100 is seen to comprise a frame or housing 102 which may be, in a preferred embodiment, comprised of, completely or partially, fiberglass or other suitable material and slightly curved in side view. The housing may comprise an outer shell 104 into which an inner shell 106 may be snugly received. The outer and inner shells, in one embodiment, being rectangular and similarly dimensioned, except that the inner shell having slightly smaller length and height dimensions so as to fit within the perimeter walls of the outer shell 104. The shells may be affixed to one another by any suitable means, including fasteners. Mounting brackets 108 are engaged, in one embodiment, to outer perimeter walls of outer shell 104, the mounting brackets being adapted to be received on a side wall panel of an aircraft interior. Inner shell 106 may have an inner face 110, which defines a cutout for receiving an inner lens 112, such as a transparent Lexan® inner lens. When the outer shell 104 and inner shell 106 are secured together, they form an interior of housing 102, into which a number of the following elements may be mounted. In one embodiment, most or all the mechanical elements are engaged to the inner shell.

In certain embodiments, the length of housing 102 is between about 50 to 70 inches, and the height is between about 18 to 32 inches. In a preferred embodiment, the length is about 61 inches, and the height is about 25 inches. In some embodiments, the length of the housing may be longer (e.g., 84 inches) or shorter (e.g., 42 inches). The aspect ratio (i.e., length/height ratio) may, in certain embodiments, be between about 1.75:1 and 6:1. The housing thickness may be between about 1.5 and 3.5 inches. A long window (whether by width or high aspect ratio) has problems that shorter windows do not, some of the problems which are provided with solutions set forth herein.

A pair of shades, inner shade 114 and outer shade 116, are adapted, in the following manner and with the following structure, to move between an open and closed position independently of one another so as to be operator selectively positioned somewhere between (or at) an up or down position, which will allow light to pass through the window, more specifically, through inner lens 112. In one embodiment, one of the inner or outer shades may be somewhat translucent (about 50% light passing through) and the other substantially opaque (about 90% plus light blocked). One or both of shades 114/116 may either be in a down or closed position which would substantially or partially prevent light from passing through inner lens 112. Furthermore, either the inner or the outer shade may be selectively set anywhere between the open and closed position to selectively control the light passing through the lens and the view from the window. Inner lens and inner shell means being toward the interior of the section of the aircraft (closer to a seated passenger), and outer shell and outer shade meaning being away from or outside with respect to the interior of the aircraft.

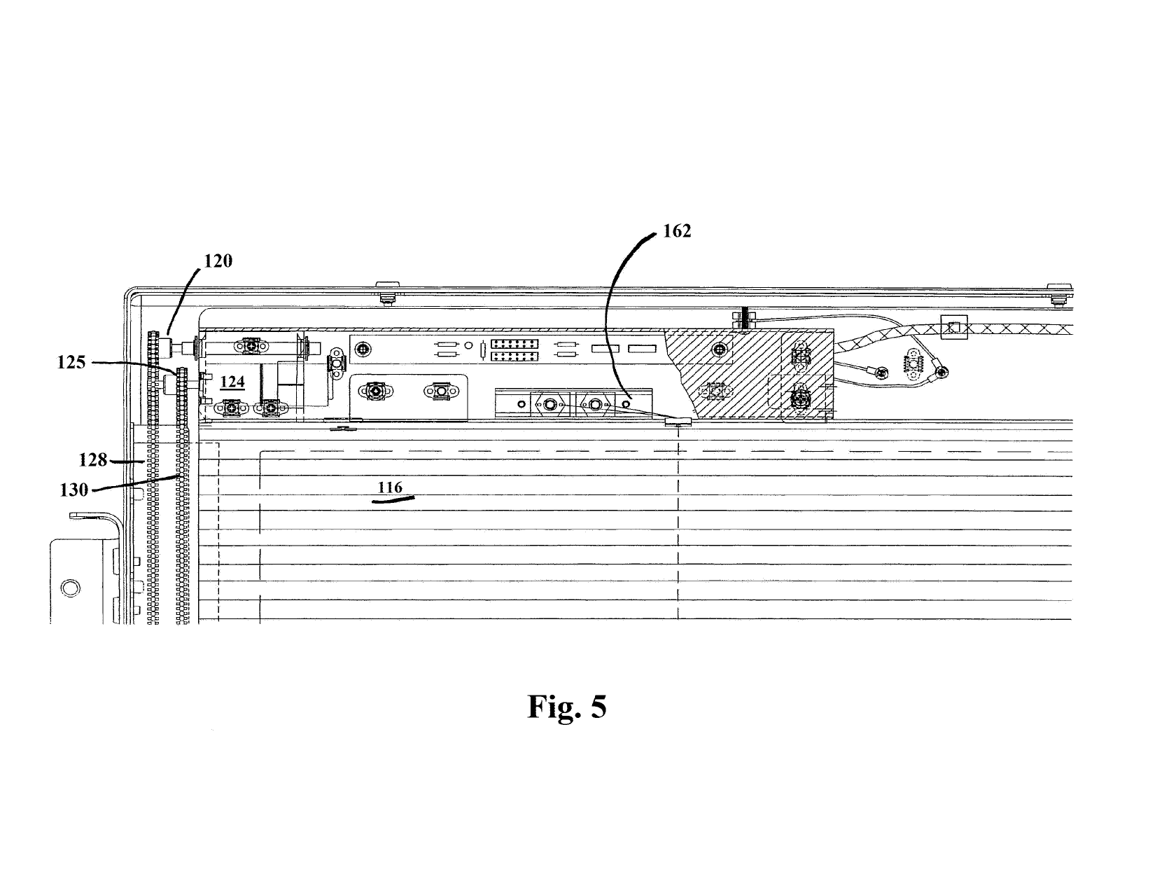

A first electric motor 118 is attached by conventional brackets or other suitable structure to the inside upper right of the inner frame as best seen in FIG. 5 and drives a first drive sprocket 119, which drive sprocket drives the first, motor driven belt 126. Mounted in the upper left-hand inside of the inner shell, as best seen in FIG. 6, is a second electric motor 124, which drives a second drive sprocket 125, which second drive sprocket 125 has entrained upon it a third belt 130, the third belt being a motor driven belt. Thus, there are two electrical motors 118/124, independently passenger operated from switches 150/151, driving motor driven belts 126/130. The motors are seen to be staggered, that is, having their drive axis staggered one slightly higher than the other. For example, in FIG. 5, motor 118 is seen to be slightly higher than motor 124 as seen in FIG. 6. Moreover, it is seen that coincident (along the same axis) with the drive shaft of motor 118 is a first idler sprocket 120 mounted on the opposite side of the frame to the motor, seen at the top left in FIG. 6. Likewise, extending the drive shaft (drive axis) of second drive sprocket 125, as seen in FIG. 5, one will find a second idler sprocket 122 mounted coincident with the drive shaft of motor 124, but on the opposite side.

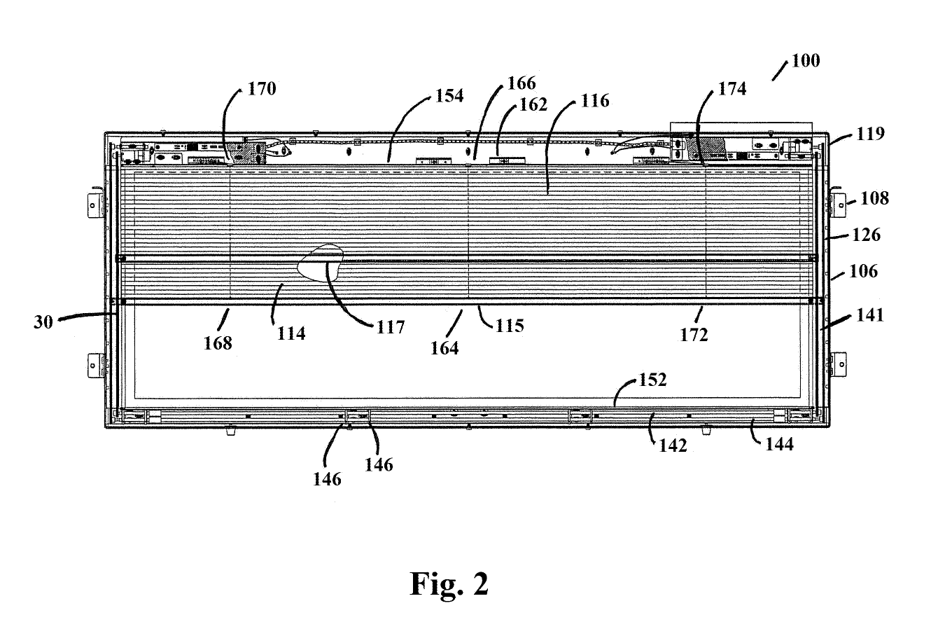

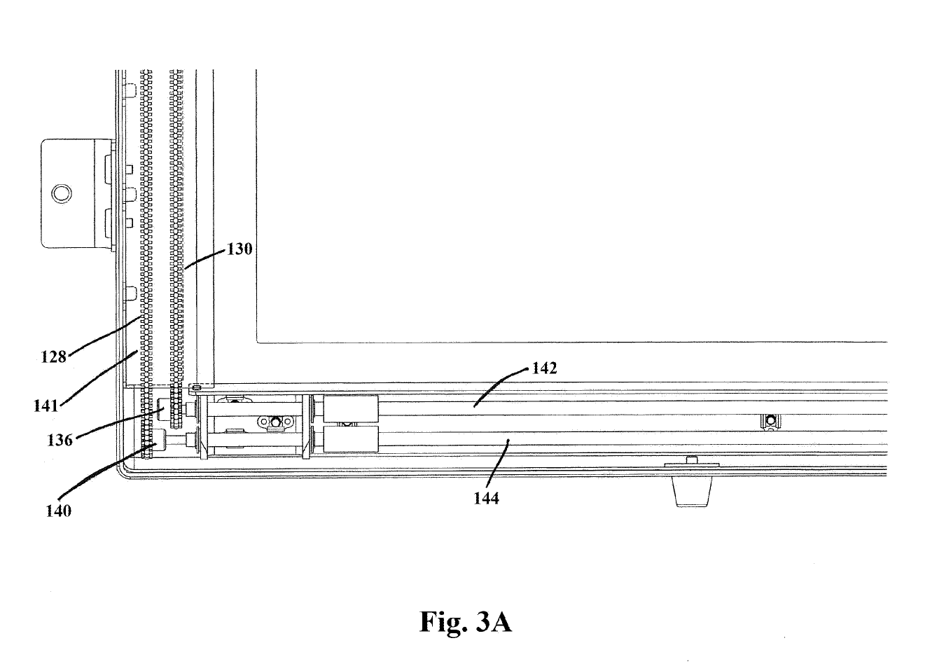

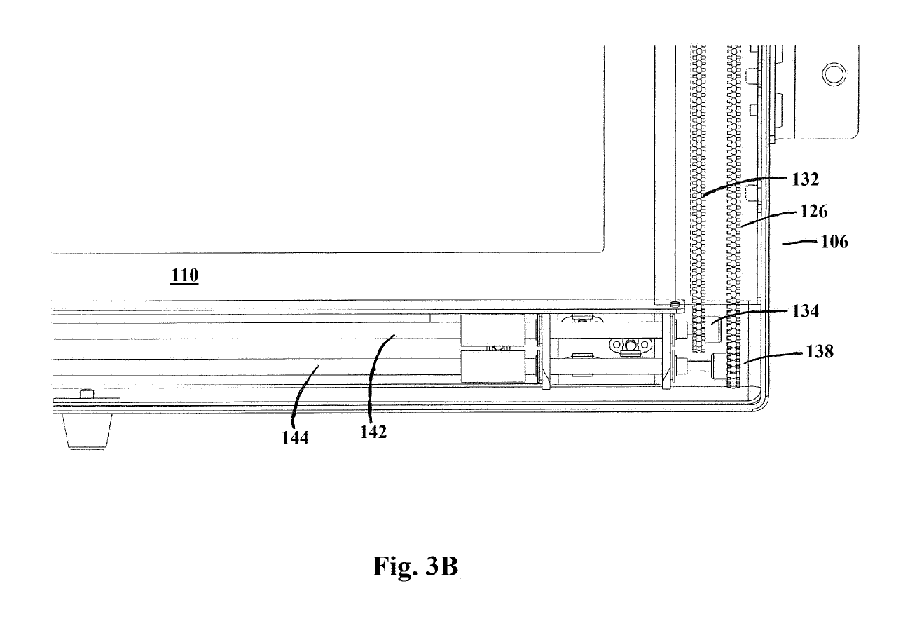

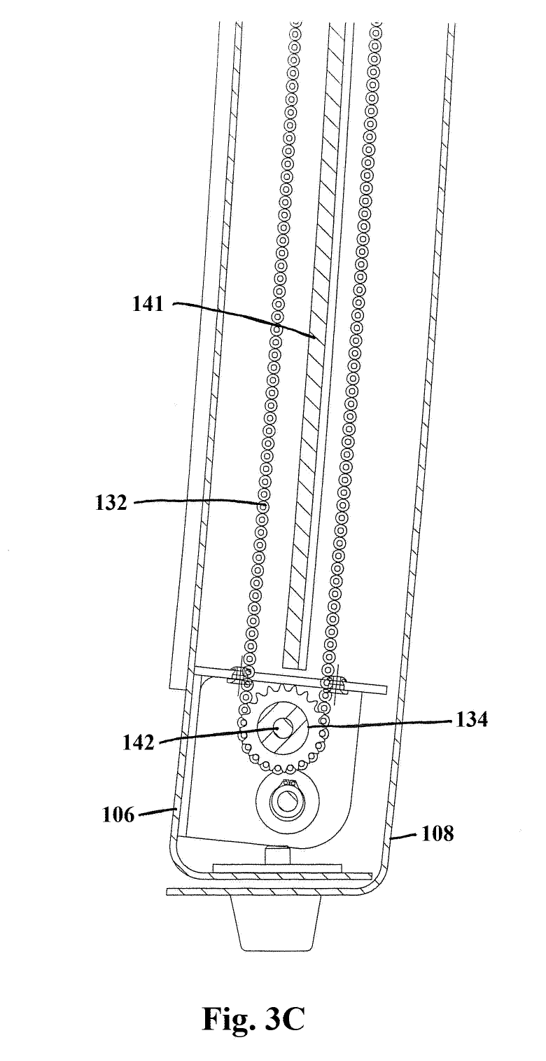

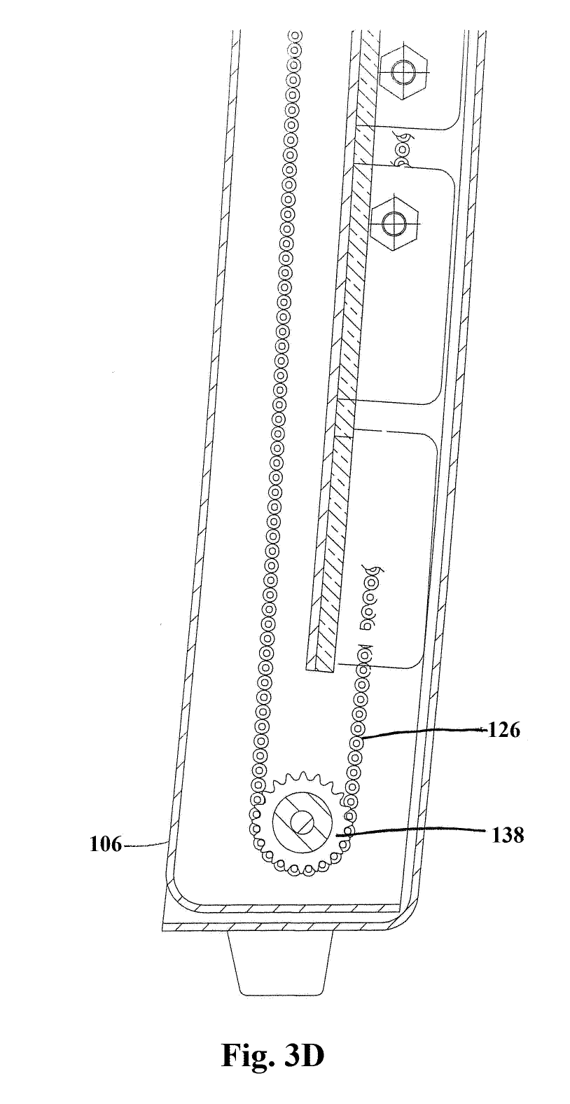

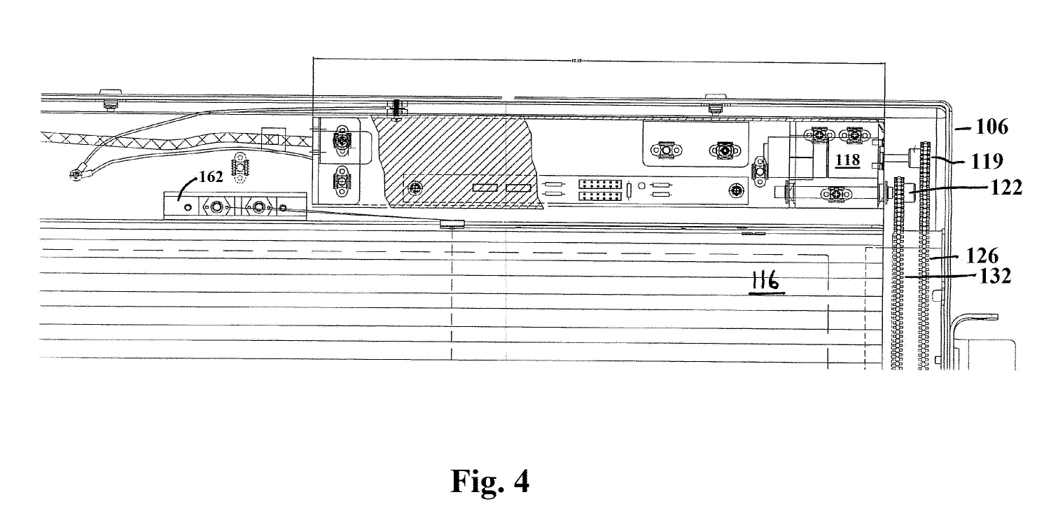

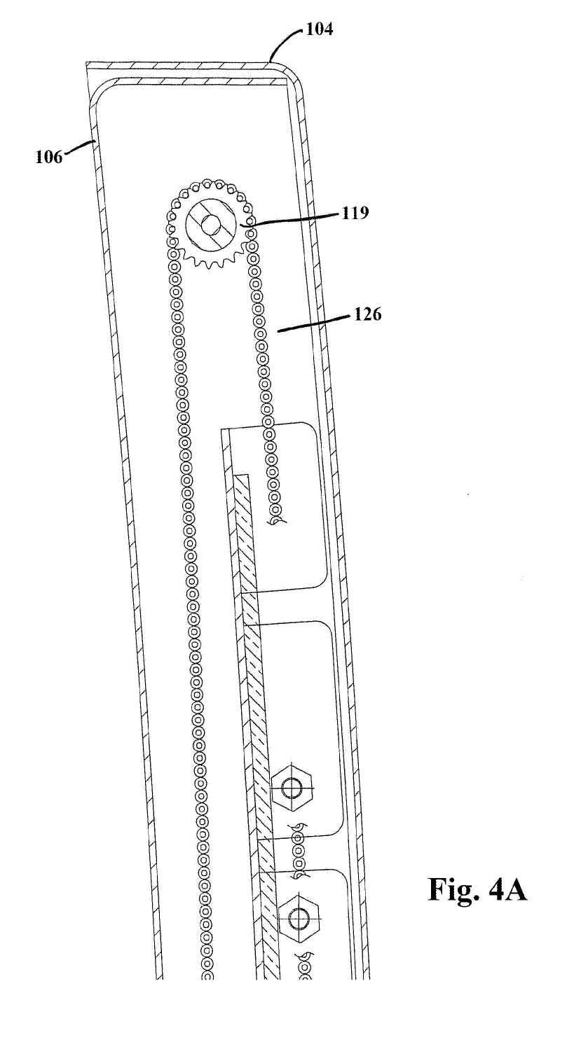

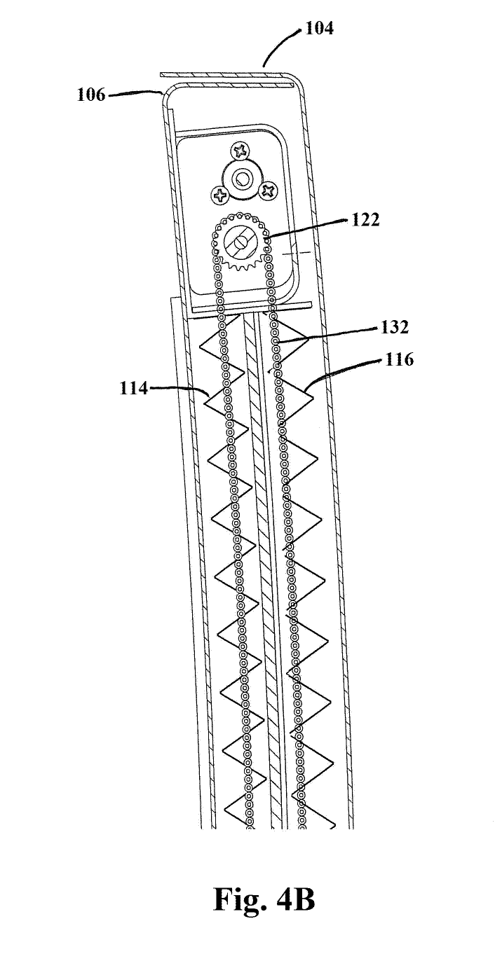

Turning now to the lower right and lower left-hand corners of the inner frame and as best seen in FIGS. 3A-3D, it is seen that there are four passive (non-driven) or “following or follower” sprockets 134/136/138/140. The term “following” or “follower” means they are not driven by direct attachment to a motor and they are removed at the removed end of the belts (mounted on the lower end corners of the housing) from the drive and idler sprockets mounted on the upper end portions of the inside of the shell. First and second following sprockets 134/136 are mounted on a live axle 142, in which in turn is mounted to the shell on stanchions 146 (which may include ball bearings), with following sprockets 134/136 engaging belts 132/130, the inner belts as seen in FIGS. 3A and 3B, and the two belts 132/130 driven by second motor 124. Likewise, third following sprocket 138 and fourth following sprocket 140 are secured at the ends of second live axle 144, which is also rotatably mounted on other stanchions 146. Following sprockets 138/140 engage belts 126/128 (see FIGS. 3A and 3B) which are driven by first motor 118. A flat (hidden) spacer 141 (see FIGS. 2, 3A, 3C) may extend vertically along the left and right side of the windows to help keep the shade rails and belts spaced apart—but will typically not extend past the inner face and will thus be “hidden” from view. FIGS. 4A and 3C together show the inner belt on the right side. FIGS. 4B and 3D show the outer belt on the right side.

FIG. 6 illustrates how belts 126/128/130/132 may be attached to shade rails 115/117 (see also FIG. 5) to help maintain alignment. The shade rails are attached to the belts at their removed ends—one end on a drive belt, the other at the same level position on a driven belt of the drive/driven position. Drive belt 130 may engage a lower shade rail 117 of outer shade 116 to move the outer shade between an open and closed position. In addition, the same attachment of the shade rails 115/117 occurs on the opposite side of each shade rail from where that shade rail is attached to the drive belt, but the attachment being to the driven belts 130/132. Thus, one attaches shade rail 115 to first belt 126, and second belt 128 at the same level, thus maintaining the shade rail in a level position as it moves between the open and closed position. Likewise, third belt 128 and fourth belt 132 (a drive/driven belt combination driven by motor 124) will be attached to the other of inner rail or outer rail 115/117 to again help maintain the shade in a level position.

A side view discloses that not only may the drive axes of motors 118/124 be staggered as seen in FIGS. 5 and 6, but in a side view, they may be slightly staggered side-to-side. The frame has a slight curve to it to conform to the curvature of the cabin panel to which it mounts (see FIG. 1A). While the axis is not a true vertical axis because of the slight bend, we can envision, in one embodiment, the two drive axes of the two motors being separated along the “vertical” axis and separated or staggered along the horizontal axis as best seen in FIG. 4B. Likewise, live axles 142/144 may be staggered.

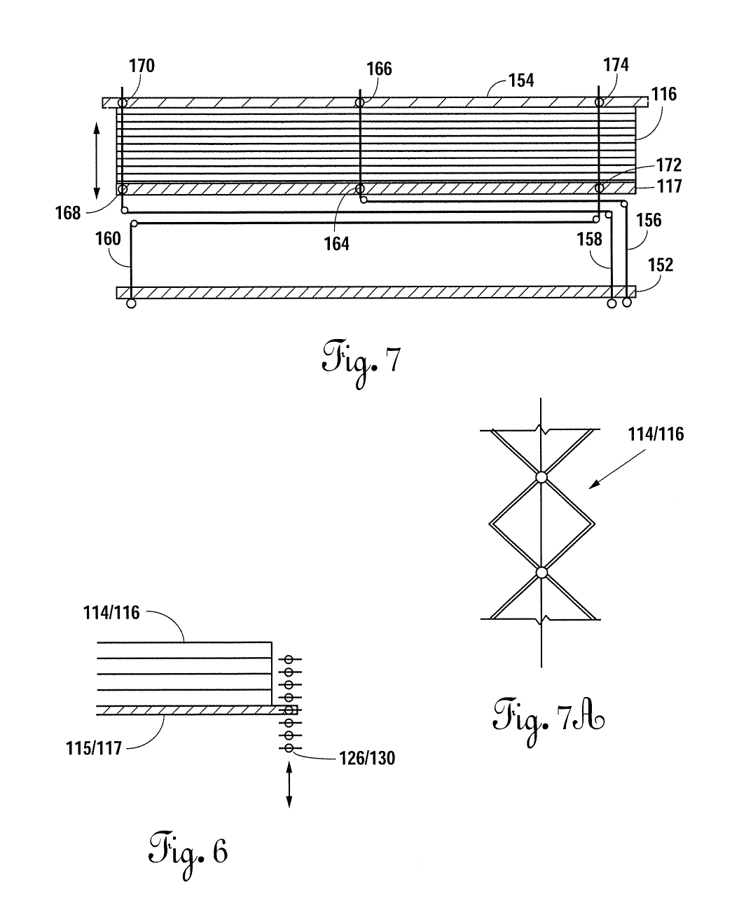

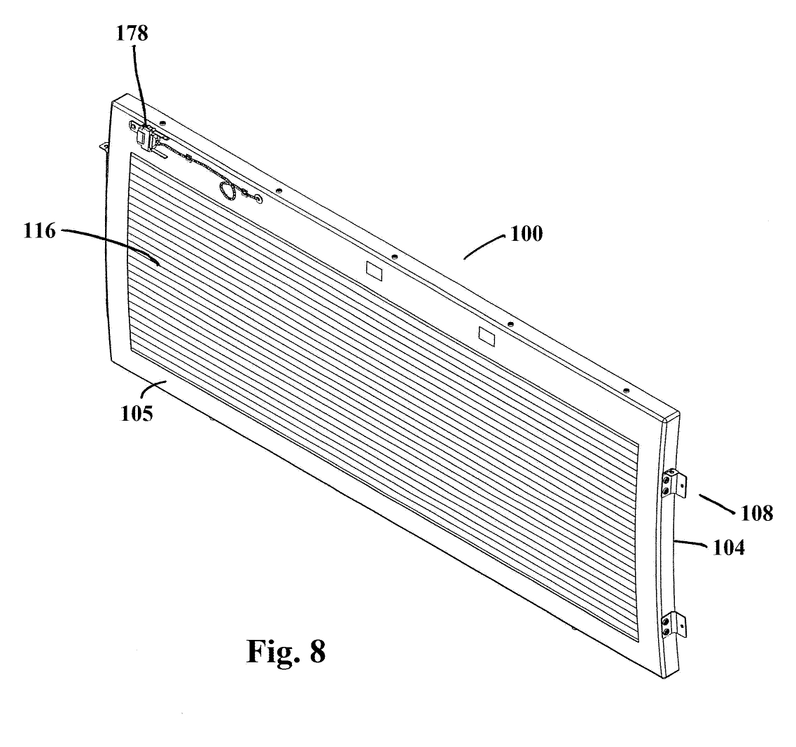

Another aspect of some embodiments of Applicant's long window is the cord system of FIGS. 7 and 7A as, in some embodiments, Applicant's system has no rear lens. That is to say, outer shell 104 merely has an opening, without a lens in it, and this creates certain problems, one of which may be sagging or billowing of the shade or shades, including the outer shade. Using an alignment system of cords may help prevent sagging of billowing of either or both shades 114/116.

Details of the shade cord system and how it is adapted to incorporate two shades, side by side (inner and outer) are seen in FIGS. 7 and 7A. FIGS. 7 and 7A illustrate a lower stationary rail 152 that extends along the lower inside of the shade below any openings so as not to be seen by a passenger. It extends from left to right along the lower bottom and engages a number of alignment cords as set forth hereinafter. It may also serve to mount the stanchions 146. Likewise, an upper stationary rail 154 which may be L-shaped, which may have the motors (and controls) attached (or may be separate) or any other suitable structure, will be adapted to receive the removed ends of a number of alignment cords that originate at lower stationary rail 152. The alignment cords will originate and finish at the lower and upper rails, and will undergo a change in direction through use of a bushing (to help prevent fraying), a Teflon loop or any other suitable means at the inner and outer shade rails, outer shade rail 117 illustrated in FIG. 7.

In one embodiment, there are three alignment cords for each shade, six total, though only the three for the outer shade are shown. More specifically, with respect to FIGS. 7 and 7A, three alignment cords 156/158/160 are illustrated. All three of the alignment cords slideably engage outer shade rail 117, so outer shade rail 117 can move up and down with respect to the three alignment cords and, while the three alignment cords will stay stationary. The alignment cords are set to pass through the shade material 114/116 (see FIG. 7A). Adjusters 162, such as sliding plates engaged to a top surface of upper stationary rail 154, may be used to apply a desired tension in the alignment cords where they engage the upper stationary rail (see FIG. 5).

Turning now to FIGS. 2 and 7, the first alignment cord 156 originating at and being physically attached to a lower stationary rail 152 trends vertically upward along the right perimeter of the frame (typically hidden from view by the inner end or faces or other structure). First alignment cord 156 slideably engages and couples to outer shade rail 117 and trends along the bottom thereof, making a 90° turn up through a grommeted hole 164 and through a second grommeted hole 166 at the top rail, makes a 90° turn and ties off at adjuster 162. Very close to (adjacent) the first alignment cord 156 and trending upward and across is second alignment cord 158, which goes past hole 164 across the outer shade rail 117 to grommeted hole 168, where it turns upward, goes through outer shade rail 117, and through grommeted hole 170, in upper stationary rail 154 and is tensioned and tied off at an adjuster 162.

The third alignment cord 160 begins at the lower left edge of the housing and is typically tied off beneath lower stationary rail 152, runs upward vertically to the bottom left-hand corner of outer shade rail 117, undergoes a change of direction at the shade rail, and is strung all the way cross to the right side, where it turns to go vertically upward through grommeted hole 172 in the outer shade rail, through grommeted hole 174 in upper stationary rail 154, undergoes a 90° change in direction and is tied off at adjuster 162.

The inner shade alignment system is substantially identical to what is illustrated in FIG. 7, and is not illustrated. What occurs on the inner shade and shade rail is that, in the view seen in FIG. 7, the three cords used on the inner shade have two originating in the lower left-hand corner and one originating in the lower right-hand corner of the lower stationary rail 152. Moreover, the cords are tied off, spaced apart from the cords see in FIG. 7 and closer to the inner walls of the housing, just as the inner shade is closer to the inner walls of the housing. Thus, for the inner shades, two cords originate on the lower left stationary rail and cross over from left to right on the inner shade rail, and one goes up the center and one goes up the far right to the upper stationary rail. One inner shade cord originates on the lower right-hand portion of the frame, trends upward, crosses all the way across the lower side of the inner shade rail, turns and goes up through the left-hand side and is tied up with adjusters typically on the upper side of the surface of upper stationary rail 154. FIG. 7A shows how alignment cords may be entrained within the folding pleats of shade material making up shade 114/116.

Although the window assembly has been discussed with respect to two shades, it should be recognized that the window assembly may only include one shade. The principles discussed herein are equally applicable to that embodiment. Additionally, more cords could be added to further stabilize a shade or as the window is made longer.

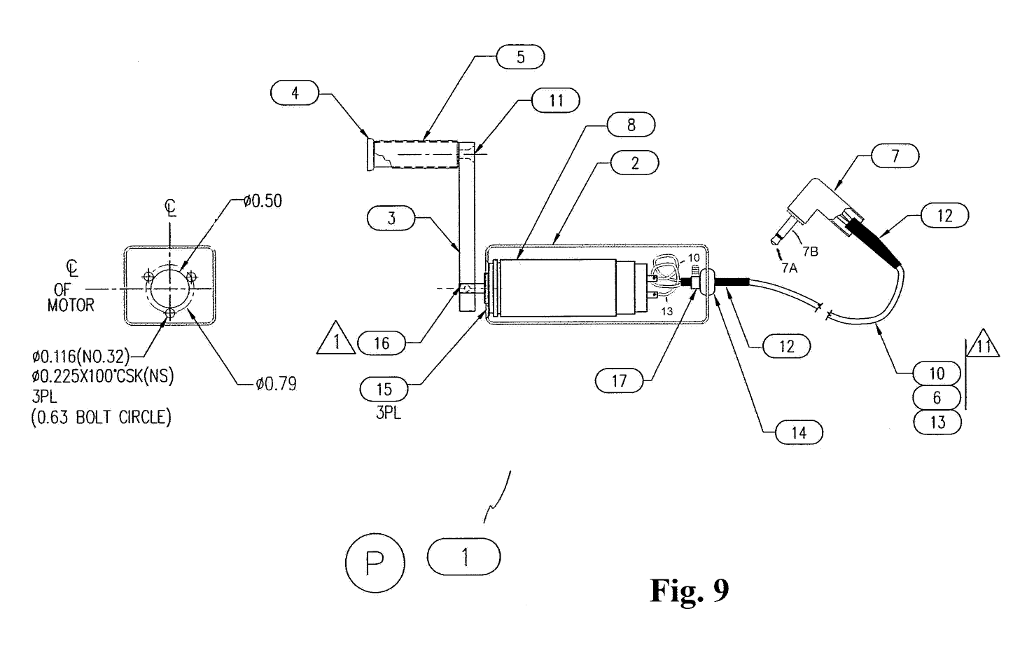

FIG. 9 illustrates a wire drive manual override 1 for engagement with an electric motor of an electrically driven window shade. Wire drive manual override 1 is designed to include a housing 2 that can be hand held. By holding housing 2 in one hand, crank arm 3 may be rotated vigorously and DC motor acting as a DC generator 8 contained inside housing 2 will convert the rotary kinetic energy generated by the hand to an electrical current output. The DC motor may, for example, be such as is available from MicroMo Part No. 2233-V0008, manufactured by Faulhaber (Germany).

This output will be transferred through, in one embodiment, a flexible insulated cord 6 (containing leads or lines 10/13) to a connector or jack 7. Jack 7 may, in one embodiment, be a headphone jack with a pair of electrodes 7A/7B. When used with the long window disclosed herewith, jack 7 is insertable into either of two override ports 148 (depending on which shade—and therefore motor, you wish to move) typically in the front wall of housing 102 or any housing of an electrical window. In one embodiment (two electric motors, two shades), placing jack 7 in one override port and cranking will cause one of the two shades to be energized and move up or down depending on the switch condition. Placing jack 7 into the other override port and cranking will energize the other window shade. Override ports 148 are connected up by conductive wires in any suitable configuration to provide DC power independently to both motors 118/124 (to the motors positive and negative terminals or poles thereof).

Wire drive manual override 1 which, in one particular embodiment, is used in Applicant's long window, may be adapted for use with any aircraft or any electrically powered, driven shade vehicular window. In one embodiment, it is used as a backup electrical power if there is failure in the main electrical power to the shade motor or motors, which power typically and usually comes from the aircraft electrical circuit.

Crank arm 3 may be mounted on an axle 4. A roller handle 5 makes it easy for a hand to grip the crank arm and for easy rotation. Cord 6 may include leads 10/13, which engage the prong (unnumbered) on connector jack 7. Pin/fastener 11 may help hold axle 4 in place. A re-enforcement sleeve 12 (which may be heat shrink) may be provided where cord 6 enters the jack and where the cord enters housing 2, which may include a rubber grommet 14 to prevent chafing and for strain relief, which may be secured with a tie wrap 17. Armature drive shaft 16 is connected to a magnet/wound coil assembly, which acts in typical generator fashion, to rotate magnets/coil windings with respect to one another to generate electric potential and a current output when engaged with a circuit, such as a DC motor circuit in an aircraft window.

In one embodiment, housing 2 of handheld wire drive manual override 1 has a longest dimension of between about 2 inches and about 6 inches, and may be either rectangular, circular or other suitable shape. The crank arm may be between about 1 inch to about 2½ inches long, thereby defining the radius of curvature of the circle transcribed by the rotation of the crank arm. In one embodiment, the rotation is stepped down in a ratio of 76 motor rotations to one rotation of the crank arm on a DC motor.

Motors 118/124, such as 24v DC motors, are engaged independently to a controller with switches 150/151 and switches are mounted in any suitable place, such as on the front of housing 102. Electrical switches may be configured in any manner, including a shade selection switch (inner, outer, both), an up or down switch or any other suitable configuration. The switches may be momentary—a quick touch and the selected shade (inner for one switch, outer for the other) will move to full up or full down, hold and release will position the shade when your finger is released.

FIG. 9 shows outer wall 105 as part of outer shell 104, but no lens used in this embodiment. Electrical connector 178 may engage the electrical circuit of the window to the aircraft's circuit.

The invention has been described with reference to specific embodiments, and several other embodiments have been mentioned or suggested. Additionally, various additions, deletions, substitutions, and modifications will be readily suggested to those of ordinary skill in the art while still achieving a long modular aircraft window. Thus, the scope of the protected subject matter should be judged based on the following claims, which may encompass one or more aspects of one or more embodiments.

1. A modular window assembly for use in an aircraft interior, the window assembly comprising:
a frame having top, bottom, front, rear, and side walls, the frame including an inner shell and an outer shell, the inner shell having a lens opening and the outer shell having an opening, the frame having a frame interior;
a transparent lens for engagement to the lens opening of the inner shell;
a multiplicity of brackets attached to the frame to engage the assembly to a side wall of an aircraft interior;
an electric motor mounted to the frame in the frame interior along the frame top, the motor having a drive shaft with a drive sprocket on the end thereof;
a shade with a shade rail, the shade and the shade rail dimensioned for receipt into the interior of the frame, the shade having an upper edge attached to the top of the frame;
an idler sprocket aligned with the motor drive shaft;
a live axle rotatably mounted to the frame in the frame interior on or near the bottom wall thereof;
a pair of following sprockets, each following sprocket fixedly engaged to removed ends of the live axle;
a belt pair for engaging the drive and idler sprockets, wherein one belt of the belts engages the first drive sprocket and a first of the following sprockets, and the other belt engages the idler sprocket and a second of the following sprockets.

2. The window assembly of claim 1, wherein the shade has a width of at least about 36 inches.

3. The window assembly of claim 1, wherein the shade has an aspect ratio of at least about 1.75.

4. The window assembly of claim 1, further comprising at least three cords adapted to maintain alignment of the shade, the cords being routed from the bottom wall of the frame to the shade rail of the shade, through the shade, and into the top of the frame, two of the cords traversing from alternate sides of the shade to the other side of the shade and one of the cords traversing from one side of the shade to an area between the other two cords.

5. The window assembly of claim 4, wherein the shade has a width of at least about 36 inches.

6. The window assembly of claim 1, further comprising a device for raising and lowering the shade, the device comprising:
a DC motor;
a housing dimensioned to be grasped and held and capable of housing the DC motor;
a hand rotatable crank engaging the DC motor through the housing and adapted to be grasped and rotated by the hand of a user;
an electrical connector jack designed to fit in an override port of the window assembly; and
electrical conductors for engaging the motor to the connector jack.

7. The window assembly of claim 1, further comprising:
a second electric motor mounted to the frame in the frame interior along the frame top, the motor on the opposite side of the frame from the first motor, the motor having a drive shaft with a drive sprocket on the end thereof;
a second shade with a shade rail, the second shade and the shade rail dimensioned for receipt into the interior of the frame, the shade having an upper edge attached to the top of the frame;
an second idler sprocket aligned with the second motor drive shaft;
a second live axle rotatably mounted to the frame in the frame interior on or near the bottom wall thereof;
a second pair of following sprockets, each following sprocket fixedly engaged to the removed ends of the second live axle;
a second belt pair for engaging the second drive and second idler sprockets, wherein one belt of the second pair engages the second drive sprocket and a first of the second pair of following sprockets, and the other belt engages the second idler sprocket and the second of the second pair of following sprockets.

8. A modular window assembly for use in an aircraft interior, the window assembly comprising:
a frame having top, bottom, front, rear, and side walls, the frame including an inner shell and an outer shell, the inner shell having a lens opening and the outer shell having an opening, the frame having a frame interior;
a transparent lens for engagement to the lens opening of the inner shell;
a multiplicity of brackets attached to the frame to engage the assembly to a side wall of an aircraft interior;
an electric motor mounted to the frame in the frame interior along the frame top, the motor having a drive shaft with a drive sprocket on the end thereof;
a shade with a shade rail, the shade and the shade rail dimensioned for receipt into the interior of the frame, the drive shaft coupled to the shade rail to lower and raise the shade, the shade having an upper edge attached to the top of the frame; and
at least three cords adapted to maintain alignment of the shade, the cords being routed from the bottom wall of the frame to the shade rail of the shade, through the shade, and into the top of the frame, two of the cords traversing from alternate sides of the shade to the other side of the shade and one of the cords traversing from one side of the shade to an area between the other two cords.

9. The window assembly of claim 8 comprising:
an idler sprocket aligned with the motor drive shaft;
a live axle rotatably mounted to the frame in the frame interior on or near the bottom wall thereof;
a pair of following sprockets, each following sprocket fixedly engaged to removed ends of the live axle;
a belt pair for engaging the drive and idler sprockets, wherein one belt of the belts engages the first drive sprocket and a first of the following sprockets, and the other belt engages the idler sprocket and a second of the following sprockets.

10. The window assembly of claim 8, wherein the shade has a width of at least about 36 inches.

11. The window assembly of claim 8, wherein the shade has an aspect ratio of at least about 1.75.

12. The window assembly of claim 8, further comprising a device for raising and lowering the shade, the device comprising:
a DC motor;
a housing dimensioned to be grasped and held and capable of housing the DC motor;
a hand rotatable crank engaging the DC motor through the housing and adapted to be grasped and rotated by the hand of a user;
an electrical connector jack designed to fit in an override port of the window assembly; and
electrical conductors for engaging the motor to the connector jack.
